(19) United States
(12) Patent Application Publication
(10) Pub. No.: US 2009/0261593 A1
(43) Pub. Date: Oct. 22, 2009

(54) Tidal pump generator

(76) Inventor: Michael Klim Culjak, Okeechobee, FL (US)

Correspondence Address: Michael Klim Culjak, 19170 NW 80th Drive, Okeechobee, FL, 34972, US

(21) Appl. No.: 12/229,579

(22) Filed: Aug. 25, 2008

Related U.S. Application Data
(60) Provisional application No. 60/988,787, filed on Nov. 17, 2007.

(51) Int. Cl. F03B 13/26

(52) U.S. Cl. 290/53

(57) ABSTRACT

This invention relates to an apparatus which generates electricity from the power inherent in the ocean tides. It uses this power to operate a hydraulic pump during the rise and fall of the tide, the hydraulic pump transmits this power to an hydraulic motor which in turn operates an electric generator. This invention can be used wherever there is access to the ocean tides.

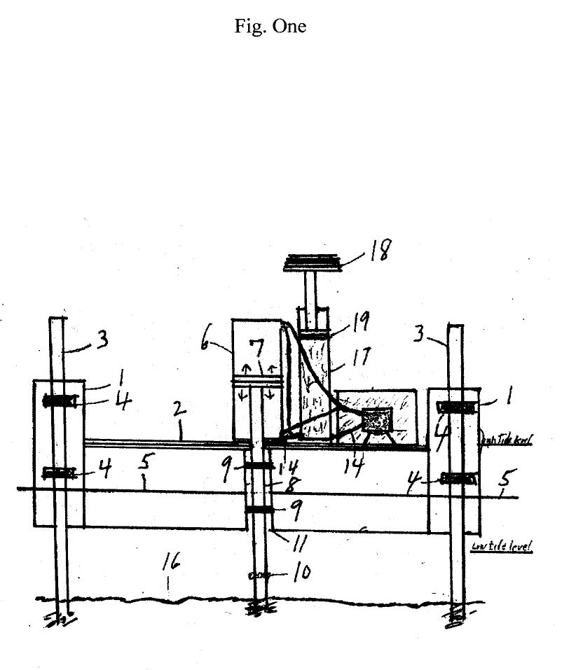

### BACKGROUND OF THE INVENTION

1. Field of the Invention

The present invention relates to creating electrical energy from the rise and fall of the ocean tides.

2. Prior Art

A tidal flow system and method for causing flow of water through waterways to flush said waterways and prevent stagnation of water and accumulation of debris therein, wherein a one-way valve means is in said waterway between the ends thereof, said valve means being closed when the depth of water on the discharge side of the valve is greater than on the inlet side of the valve and said valve means being opened when the depth of water on the discharge side of the valve is less than on the inlet side thereof, the depth of water at least on the discharge side of the valve being controlled by tidal action. As known from U.S. Pat. No. 3,733,830

Float/weights are positioned in the tidal water, arranged to rise and fall with the tides. A power unit including a cylinder and piston is arranged with the piston connected with the float/weights, and draws water into it upon the float/weights rising and forcing it into a storage unit upon the float/weights dropping. The storage unit includes a cylinder and a weighted piston. After the storage unit is filled, the water is let out to drive a water turbine and generator. The apparatus may use a closed circuit for the water, or an open circuit and draw it directly from the sea and return it to the sea. In the use of a closed circuit, instead of sea water, the apparatus may use fresh water, or oil. The apparatus is also adapted to use compressed gas instead of liquid. As known from U.S. Pat. No. 4,598,211

A tide motor energy source includes a tidal piston with a valved chamber. The piston drives a hydraulic ram to generate electrical power through a pressure accumulator and hydraulic motor. The ram can be locked hydraulically to enable the tidal piston to be held fixed at a desired elevation and the valves in the chamber permit it to be filled with water or air. The piston with its chamber filled with air at its low tide position and then released for controlled ascent while submerged acts as a submerged float for driving the ram upwardly while the tide runs in during one phase of its operation. The piston with its chamber filled with water while locked at its highest position as the tide begins to run out, and then released to fall under control, acts as a weight suspended in air after the water level drops below the piston for driving the ram downwardly during the second phase of its operation. The rising and falling motion of the tidal piston is used as the energy source, as known from U.S. Pat. No. 4,208,878

A tide motor useful for converting periodic rising and falling water levels to useful work such as electric power generation includes a primary piston having a large enclosed chamber that can selectively be filled with air for generation of upward thrust when submerged in rising tidal water or filled with water for generating downward gravitational thrust when the piston is suspended in air above a dropping tidal water level. Cyclic filling and emptying of the chamber is programmed to coordinate piston positions and water level positions, and the piston can be locked in either up or down position to achieve maximum flotation and gravitational thrust forces. An auxiliary tidal piston that can be locked in a down position has an upper water chamber provided with flood valves and an air filled, sealed flotation chamber below. The auxiliary piston is located near the primary piston, and is designed to have positive buoyancy when its respective chambers are filled with water and . . . as known from U.S. Pat. No. 4,185,464

A system for extracting useful energy from sea currents. A pair of drag inducing devices is disposed in the sea current, and connected by cables to a windlass at a location upstream of the drag devices. Each drag device has a selectably variable drag resistance in the sea current, and the drag devices are controlled so as to reciprocate toward and away from the upstream location. The reciprocating movement of the drag devices is converted into rotary motion by the windlass, and the rotary motion is used to perform useful work, as know from U.S. Pat. No. 4,313,059

An apparatus and method for utilizing natural energy in the production of electricity having an alternating current is disclosed wherein the natural energy is utilized to pressurize hydraulic fluid. The hydraulic fluid is temporarily stored within high pressure storage tanks to be utilized in the production of electricity. This electricity is supplied as needed to various consumers. Excess electricity which is generated by hydro electric devices driven by the pressurized hydraulic fluid is utilized to pressurize additional hydraulic fluid. The additional hydraulic fluid is then supplied to the high pressure storage tanks to be used at a later time for the production of electricity. In this way, excess electricity that is produced from the pressurized hydraulic fluid is reconverted into pressurized hydraulic fluid which may be stored in the high pressure storage tanks until needed. The high pressure storage tanks may be initially charged with a compressible fluid which is compressed . . . as known from U.S. Pat. No. 4,206,608

This invention is a multiple diverse energy source driven energy integration and multiple use-point system: which includes system air pressure compensated variable pressure and volume delivery of compressed air from multiple air compression stations which discharge and store compressed air into an included interconnecting collection storage and distribution conduit multiple module grid system; of largest needed and commercially available size pipe to keep the pressure drop to a minimum, and from which the compressed air is withdrawn at multiple points of need; when and as needed, through synchronized dual-precision-controls to turn, at optimum RPM speed regardless of varying work loads, air motor drives for operation of conventional electrical generating equipment with varying customer-use-demand output work loads. The conduit-pipe systems are arranged in interconnecting, but isolable, multiple module grids ranging in size from those needed, for example, for a small town or . . . as known from U.S. Pat. No. 4,118,637

The presented invention provides of hybrid thermodynamic cycle and a hybrid energy system as a method of reduction of fossil fuel consumption, maximum utilization of energy from renewable energy sources, increasing hybrid energy systems' efficiency and operating time, and transforming these systems from supplemental to primary energy producers. The hybrid thermodynamic cycle is a method of integration of incompatible types of energy, such as solar radiation, fossil fuel, kinetic energy of wind, of the ocean tide and wave, and of the river water. The integration process involves collection, conversion, operation, storage, and transmitting of incompatible energies using kinetic energy collectors, compressors, solar and air heat energy exchangers, air and thermal storages, piston and gas turbine heat engines, electrical generators, and air and electrical transmission lines. Surrounding air is used as an intermediate working substance in the hybrid thermodynamic cycle. A hybrid . . . as known from US 2006/0055175 A1

The assembly comprises an elongated float member which floats on the surface of a body of water having waves moving therealong. A support arm freely pivotally connects to the float member for maintaining the float member parallel to the surface of the water. The support arm member is effective to maintain the float member with its longest dimension disposed in a direction parallel to the length of the waves moving along the surface of the body of water. A transmission assembly is responsive to the support arm member as the float member moves up and down with the movement of the waves to produce a rotational movement in a transmission shaft from which energy may be derived. Various features directed to the specific configuration of the float member, support arm member, transmission mechanism including the structure of a transmission shaft and a clutch mechanism are also disclosed, as known from U.S. Pat. No. 4,718,231

This invention is a multiple diverse energy source driven energy integration and multiple use-point system: which includes system air pressure compensated variable pressure and volume delivery of compressed air from multiple air compression stations which discharge and store compressed air into an included interconnecting collection storage and distribution conduit multiple module grid system; of largest needed and commercially available size pipe to keep the pressure drop to a minimum, and from which the compressed air is withdrawn at multiple points of need; when and as needed, through synchronized dual-precision-controls to turn, at optimum RPM speed regardless of varying work loads, air motor drives for operation of conventional electrical generating equipment with varying customer-use-demand output work loads. The conduit-pipe systems are arranged in interconnecting, but isolable, multiple module grids ranging in size from those needed, for example, for a small town or . . . as known from U.S. Pat. No. 4,167,372

A tide-driven generator comprising a prime mover connected between an inlet conduit which is suspended at a fixed depth near the surface of the ocean and a discharge conduit which is supported on or near the ocean floor. A plurality of outwardly directed ports in the discharge conduit wall enable the continuously flowing, outgoing undertow to entrain and induce flow in the discharge conduit so that there is flow in the system, even at outgoing tide. As known from U.S. Pat. No. 4,327,297

An electric power generator apparatus that generates electrical power from the tidal movements of a body of water by employing multiple energy producing systems. Those energy producing systems include: (1) a moveable tank system associated with hydraulic cylinders in which the upward and downward movements of the tank relative to the tide are used to generate electrical power; (2) an enclosure system in which the controlled inflow and outflow of water between the enclosure and the surrounding body of water is used to generate electrical power; (3) a bellows system in which the effects of the tidal movements are used to force water from the bellows tank through a generator thereby producing electrical power; and (4) a buoyant mass-actuated piston system in which the movement of floating objects (such as docked ships) relative to the tide is used to generate electrical power. As known from U.S. Pat. No. 5,426,332

The present invention relates to an electric power generator apparatus that generates electrical power from the tidal movements of a body of water by employing multiple energy producing systems. Those energy producing systems include: (1) a moveable tank system associated with hydraulic cylinders in which the upward and downward movements of the tank relative to the tide are used to generate electrical power; (2) an enclosure system in which the controlled inflow and outflow of water between the enclosure and the surrounding body of water is used to generate electrical power; (3) a bellows system in which the effects of the tidal movements are used to force water from the bellows tank through a generator thereby producing electrical power; and (4) a buoyant mass-actuated piston system in which the movement of floating objects (such as docked ships) relative to the tide is used to generate electrical power. As known from U.S. Pat. No. 5,872,406

The invention, which provides a system for harnessing power from current flow or tidal movement in a body of water, comprises first and second hydro-pneumatic chambers each having ingress and egress below the water surface near the river or ocean floor and water gates operative to open or seal the ports to the passage of water. In an exemplary embodiment, the gates are sychronized by shafts so that the ingress ports of each chamber are connected to the egress ports of each other chamber. Thus, one set of gates is closed, while the other is open, thereby allowing water to flow into one chamber and build air pressure therein and allowing water to flow out of the other chamber and create a partial vacuum therein. A pipe connects the chambers, and an air turbine harnesses the air movement within the pipe. When water levels are equilibrated, the open set of gates is closed by a counterweight, and the other set is allowed to open by natural force of the water differential. The water . . . As known from U.S. Pat. No. 5,074,710

A tide-powered electrical generator wherein the energy from successive rising tides is stored in the form of potential energy for selective conversion to electricity. A float is constrained to vertical motion and it raises on successive tides a weight by means of a jack bar to reach a maximum predetermined height on a stable support structure where the weight is supported until release for the generation of electricity. Provision is made for the prevention of damage to the generator by excessive tidal rises. A known from U.S. Pat. No. 3,959,663

A power transfer system for generating electrical energy from recurring wave and tidal movement within the ocean. The system comprises a pressure sensing device, such as an array of pressure transducers, positioned at the ocean floor below water level and at a location of wave movement for (i) registering changes in height of water above the pressure sensing device and (ii) providing a power output corresponding to changes in force associated with the changes in the height of water. A transfer medium is coupled at one end to the pressure sensing device and extends underground to a second end at a shore location adjacent the location of wave movement for transmitting the power output of the pressure sensing device to the shore location. A bank of storage batteries is coupled to the transfer medium at the shore location for receiving the power output from the transfer medium and for storing the power output as a useful form of energy. as known from U.S. Pat. No. 5,955,790

### SUMMARY OF THE INVENTION

The main objective of this invention is to convert the energy inherent in ocean tides into electrical energy and to do this as efficiently and simply as possible.

The invention uses the rise and fall of the tide as actuator for a large hydraulic pump mounted vertically on the deck of a vessel.

The ram or shaft connected to the pump piston is let through the deck and hull of the vessel and is firmly set into the bottom of the inlet, canal or any other shallow place along to shore which is protected from the waves.

The vessel itself is held horizontally in place by piles or any other means practical for the particular installation so as to allow free movement of the piston ram as the vessel rises and falls with the tide. As the tide goes out and the vessel comes down the pump piston will push the hydraulic fluid up in the cylinder and through a high pressure line. The velocity and pressure of the fluid can be determined by the diameter of the pump cylinder and the rate at which the vessel rises with the tide. As the tide comes in and the vessel goes up the pump piston will exert a downward pressure on the hydraulic fluid and push it through a high pressure line at a velocity and pressure the same as on the upward stroke of the piston.

In both instances as the vessel pump piston goes up or down a return line brings the hydraulic fluid to the other side of the pump's piston.

The two high pressure lines from the deck mounted hydraulic pump conjoin and enter a large hydraulic accumulator of weight-loaded design. The accumulator serves two purposes. Primarily its purpose is to maintain the same pressure provided by the hydraulic deck-mounted pump. Its secondary function is to provide a reserve of hydraulic fluid.

From the hydraulic accumulator a high-pressure line runs to a hydraulic motor. This high-pressure line has a one-way pressure valve to insure the proper pressure for the hydraulic motor.

The hydraulic motor is driven by the high-pressure fluid coming from the hydraulic accumulator. This motor has a return line going to the hydraulic pump. The return line bifurcates with one return line entering the top of the hydraulic pump cylinder and the other entering the bottom of the hydraulic pump cylinder.

In each of these return lines is a valve allowing the hydraulic fluid to return to the unpressured side of the hydraulic pump cylinder. On the pressured side of the hydraulic pump cylinder the valve closes to prevent back pressure at the hydraulic motor.

The hydraulic motor drives an electric generator. It should be emphasized that theoretically this electric generator can be of any size, up to and equal to the size of generators used in convention power plants.

### BRIEF DESCRIPTION OF THE DRAWINGS

1. A vessel
2. The deck of the vessel
3. Piles at the four comers of the vessel, fixed in the bottom of the inlet
4. The fittings holding the piles to the vessel and allowing vertical movement of the vessel
5. The waterline of the vessel
6. An hydraulic pump cylinder containing hydraulic fluid mounted in the center of the deck
7. A piston with a shaft to force the hydraulic fluid up or down in the pump cylinder with the rise and fall of the tide and the resultant rise and fall of the vessel
8. The pump piston shaft (revealed in a cutaway view) which is firmly connected to the bottom
9. Guides to help keep the piston shaft in alignment, also in a cutaway view
10. An universal joint
11. A circular aperture in the hull for the piston shaft and the shaft guides (cutaway view)
12. An electrical generator
13. A hydraulic motor which is operated by the high pressure fluid from the hydraulic pump mounted in the center of the deck to drive the generator
14. The high pressure lines from the deck-mounted hydraulic pump to the hydraulic accumulator
15. The return lines from the hydraulic motor to the deck-mounted hydraulic pump cylinder
16. The bottom of the inlet
17. An hydraulic accumulator
18. The accumulator weights which maintains a constant hydraulic pressure
19. Valves
20. One way pressure control valve

### DETAILED DESCRIPTION OF THE INVENTION

This invention is designed to utilize the predictable rise and fall of the ocean tides as power to operate a hydraulic pump which drives a hydraulic motor which drives an electric generator.

Previous attempts to capture the power of the tidal pulse, that is, the rising and falling of the ocean water, have largely failed in that they were unable to provide a significant amount of electricity and/or the devices to produce electricity from the rise and fall of the tide are complicated and largely impracticable.

This invention is a simple and efficient way of generating electricity from ocean tides

A vessel (1) is situated in a place outside the force of the tidal currents and is fixed in place by piles (3), or by other means, at the four corners of the vessel.

On the deck is a hydraulic pump (6) with a piston (7) with a shaft (8), all of which is fixed in an upright position on the deck, the hydraulic pressure inside the cylinder can be as high as the displacement of the vessel itself.

The shaft connected to the piston extends downward through an aperture (1) in the deck and hull of the vessel and connected to an extension of the shaft which is fixed firmly in the bottom of the inlet (16).

On the deck near the hydraulic cylinder is a hydraulic accumulator (17).

The hydraulic pump (6) is connect to the hydraulic accumulator (7) by two high pressure lines (14) with one way valves, one from the top of the hydraulic pump cylinder (6) and the other from the bottom of the hydraulic pump cylinder (6) both of these high pressure lines (14) work alternately with the rise and fall of the barge during the tidal cycle and join before entering the hydraulic accumulator (7).

From the hydraulic accumulator (7) a single high-pressure line with a non-return pressure control valve connects to the hydraulic motor (13).

There are two return lines (15) with one way valves from the hydraulic motor to the hydraulic pump cylinder, one going to the top of the hydraulic pump cylinder and the other to the bottom of the hydraulic pump cylinder.

The hydraulic motor (13) is connected to an electric generator (12) of whatever size desired.

1. A Tidal Pump Generator which can be installed wherever there is a coastal tide and where said Tidal Pump Generator can continuously produce electricity at a fixed rate up to 75 MW or more as the tide rises and falls, comprising: a) a vessel in an inlet, canal or similar waterway where the ocean tide has access but is protected from waves; b) a double-acting hydraulic cylinder pump mounted on the deck of a vessel with the shaft driving the hydraulic cylinder pump piston penetrating the deck and bottom of the vessel, said shaft anchored at the bottom of the inlet, canal or other waterway; c) an hydraulic accumulator; d) an hydraulic motor; e) an electric generator.

2. The system of claim 1, the vessel referred to must be orientated horizontally in a fixed position by whatever means most feasible so as to minimize binding of the hydraulic pump's piston shaft.

3. The system of claim 1, the hydraulic pump mounted on the deck of the vessel is designed to force hydraulic fluid by means of a piston through a high-pressure line as the vessel rises with the tide and does the same through another high-pressure line as the vessel falls with the ebbing tide reversing the thrust of the piston.

4. The system of claim 1, the high-pressure lines from the deck-mounted hydraulic pump join and go to a hydraulic accumulator which maintains the hydraulic pressure and a reserve of hydraulic fluid.

5. The system of claim 1, a high-pressure line connects the hydraulic accumulator to an hydraulic motor with return lines to the deck-mounted hydraulic pump, one return line with a one-way valve going to the top of the deck-mounted hydraulic pump cylinder and the other return line also with a one-way valve going to the bottom of the deck-mounted hydraulic pump cylinder.

6. The system of claim 1, the hydraulic motor is connected to and drives an electric generator of desired size which connects to the power grids.
